(19) United States
(12) Patent Application Publication
(10) Pub. No.: US 2009/0146950 A1
(43) Pub. Date: Jun. 11, 2009

(54) METHOD AND SYSTEM OF VISUALISATION, PROCESSING, AND INTEGRATED ANALYSIS OF MEDICAL IMAGES

(75) Inventor: Francesco Maringelli, Monza (IT)

Correspondence Address: KNOBBE MARTENS OLSON & BEAR LLP, 2040 MAIN STREET, FOURTEENTH FLOOR, IRVINE, CA, 92614, US

(73) Assignee: SR LABS S.R.L., Brescia (IT)

(21) Appl. No.: 11/718,224

(22) PCT Filed: Oct. 28, 2005
(86) PCT No.: PCT/EP05/55636

§ 371 Date: Apr. 27, 2007

(30) Foreign Application Priority Data
Oct. 29, 2004 (IT) FI2004A000223

(51) Int. Cl. G09G 5/08; H04N 5/225; G10L 15/22; G06T 7/00

(52) U.S. Cl. 345/158; 382/103; 704/275; 382/128; 704/E15.04

(57) ABSTRACT

The present invention concerns a method and a system for the management of a station of visualisation, processing and analysis of images based on not manuals commands, particularly optical and vocal, and able to provide a feedback to the user to direct the further exploration of the medical images.

### FIELD OF THE INVENTION

The invention is related to the field of the visualisation, processing and analysis of medical images and to the methods of visualisation of the same.

### STATE OF THE ART

In the medical field, tools such as RX, Magnetic Resonance, Cat scan and other diagnostic means used to create images of structures and tissues inside the human body are always more employed.

These images are generally printed on special supports, normally transparent film, and are consulted, on proper devices, through transillumination.

The diagnostic systems of last generation are able to produce and to memorize images without using press supports and are able to directly provide the produced images to digital stations of visualisation.

These stations consist of one or more monitors connected to a computer system that is able to check, manipulate and process the visualized image.

This kind of stations allow to work with traditional images that have been stored on traditional supports, by scanning them in order to convert them into digital format. Nevertheless these digital stations of visualisation still result quite complicated to use for the majority of the users and they require additional operations for the analysis of the complete image. In fact the digital image reproduced on a screen (“softcopy”) has a spatial resolution (number of elementary information reproduced) and a grey levels resolution (number of colour tones) lower than the corresponding resolutions of the printout on transparent film (“hardcopy”); as a consequence, the operator/user is forced to cope with the lower resolution by using electronic tools of manipulation of the digital image such as the enlargement (“zooming”), the dissection of the grey levels (“windowing”, “leveling”), etc.

This has negative consequences on the rapidity of the images consultation, a very important parameter in this activity.

Moreover in the diagnostic process a fundamental element is the accuracy or rather the correct interpretation of the medical condition which results from the displayed image.

The user interface of the current digital stations of visualisation forces the doctor to move his gaze out of the image under examination in order to interact with a toolbar using the mouse or the keyboard. Therefore, the diagnosis executed using the “softcopy” of the image related to a clinical test may require a longer time with respect to the analysis of the “hardcopy”, and it also causes the radiologist to look away from the interest region of the image and this can represent a reason for inattention producing a negative effect on the accuracy of the diagnosis.

Moreover, the use of the above-mentioned stations necessarily involves a preventive training of the user that obviously requires some time and represents a further obstacle to the diffusion of this kind of systems in the medical field. This preliminary training must not be directed only to the commands usage of the station of visualisation but also to allow the user to know how to catch the important details in the digital images displayed so as to reach correct conclusions and diagnosis.

Among the workstations equipped with so-called eye-tracking devices, capable of detecting the direction of the user gaze, methods are known, in the state of the art, to survey visual exploration—also known as “scanpath”—carried out by the user/operator. These methods define an ideal path of visual exploration through, for instance, the analysis of the position, of the duration and of the sequence of the fixations performed by the subject in order to be able to discriminate, according to the type of obtained scanpath, the exploratory ability of the subject and therefore its level of training.

It is clear how, according to these information, is possible to plan an appropriate strategy of training for the attainment of the ideal “scanpath” as regards to a determined activity.

Considering the stations of visualisation of medical images, for instance, it would be desirable to be able to help the operator in the analysis of the displayed image not only simply analyzing the exploratory path to compare with others through statistical analysis—as it happens in the methods of the state of the art—but also producing a series of feedback which are variable according to the kind of running analysis and specifically addressed to the operator/user himself.

In brief, the drawbacks of the actual digital systems of visualisation can be summarized through the followings points:
on workstations, the vision of images related to clinical tests, results more difficult and complicated in comparison to the analogous operation performed with images printed on film support;
the control of workstations with traditional methods based on toolbars, mouse and/or keyboard results slow and it can be a reason for inattention to the user/operator since it forces him to look away from the area of interest;
the management of the various medical images related to a specific case, their retrieval from the system memory and their processing require additional operations that extend the time of analysis of the medical case under investigation. Today this problem is even more important considering the current trend of increasing the number of medical images per single case in order to obtain a diagnosis as complete and accurate as possible;
workstations don't always show the images in a coherent way according to the flow of traditional work;
workstations require a suitable preliminary training before the user is able to use it in the proper way;
the current systems of visualisation of medical images don't offer any feedback to the user related to the quality and/or to the quantity of the spatial and/or temporal distribution of his own attention during the examination of the images themselves.

The present invention overcomes the drawbacks described above introducing a method and a system for the management of stations of visualisation of medical images in a non-manual way, a method and a system that is capable of interfacing with eye-tracking and/or voice input devices that allow the management of the station of visualisation of digital images exclusively using the gaze and the voice instead of the usual user interfaces such as keyboards, mouse, trackball, optic pens etc.—including means for the analysis of the observation procedure of the user and means for the generation of appropriate feedback fit to guide the user himself in order to optimize his activity.

### PURPOSE OF THE INVENTION

A purpose of the present invention is, therefore, to disclose a method and a system for the visualisation of medical images based on non-manual user interface and capable of providing to the user feedback related to the quality of his own strategy of observation and to the effectiveness of his own interpretation of the visual data, valuable information that the user himself can use to improve his performances.

Another purpose of the present invention consists in the optimisation of the management of the image by the station of visualisation, optimisation in terms of positioning and orientation of the image and in terms of management of the patient data.

A further purpose of the present invention is to realise said method and system for the management and the visualisation of medical images in a way that is compatible with eye-trackers devices and speech recognition modules.

### SUMMARY OF THE INVENTION

It is an object of the present invention a method and a system for the visualisation, the processing and the analysis of digital medical images that employs non-manual commands, preferably optical commands using an eye-tracker device and/or vocal command using a speech recognition module, and is capable of providing automatic feedback to the operator following an analysis of his own visual exploration and his own attentive distribution.

### BRIEF DESCRIPTION OF THE FIGURES

FIG. 1 Shows a block diagram of the architecture of the application that realises a medical console for the visualisation and the analysis of digital medical images.

FIG. 2 Shows the flow chart of the method according to the present invention.

FIG. 3 Shows the flow chart of the routine of filtration of the raw data incoming from the eye-tracking device.

FIG. 4 Shows the flow chart of the routine of optical command definition.

FIG. 5 Shows the flow chart of the sub-routine of image processing.

FIG. 6 Shows the flow chart of the “state machine” sub-routine.

### DETAILED DESCRIPTION OF THE INVENTION

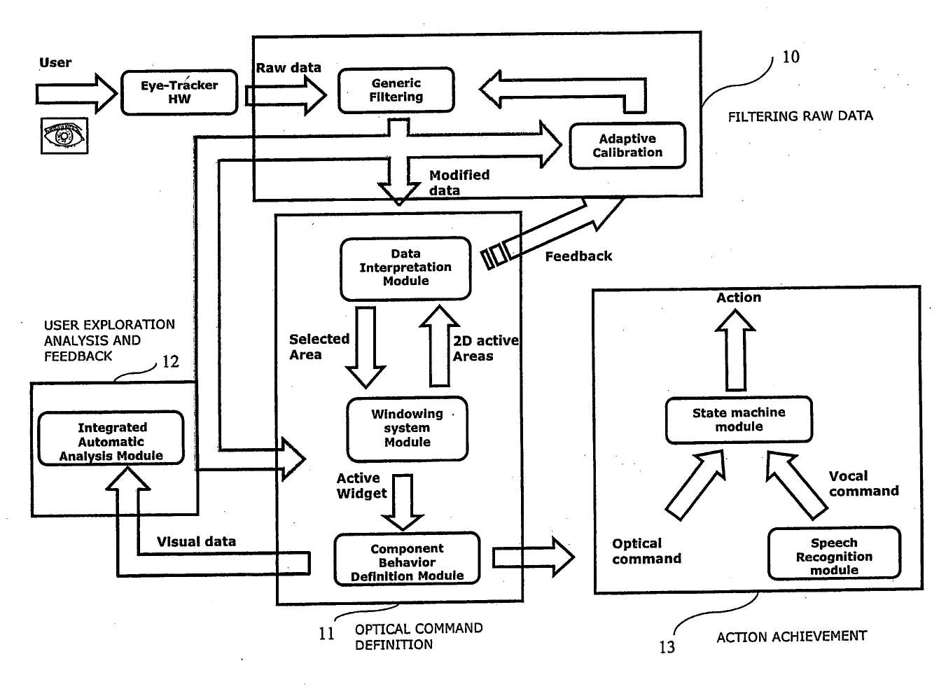

With reference to FIG. 1 the method object of the present invention consists of the following modules: a filtering module 10 in which the coordinates of the user gaze are processed in order to normalise the raw data incoming from the used eye-tracking device, to make them more stable and to eliminate the possible calibration errors; a module, so-called “optical command definition” 11 responsible for the management of the graphical interface of the application and for the link with the commands given by the user; a module of integrated automatic analysis 12 that provides the user with an automatic feedback based on the analysis of the visual exploration performed by the subject and of his attentive distribution and finally a module, so-called “achievement of the action” 13, which determines the action to perform taking into consideration the current state of the application, the selected optical commands and/or of the vocal commands received by a module of speech recognition.

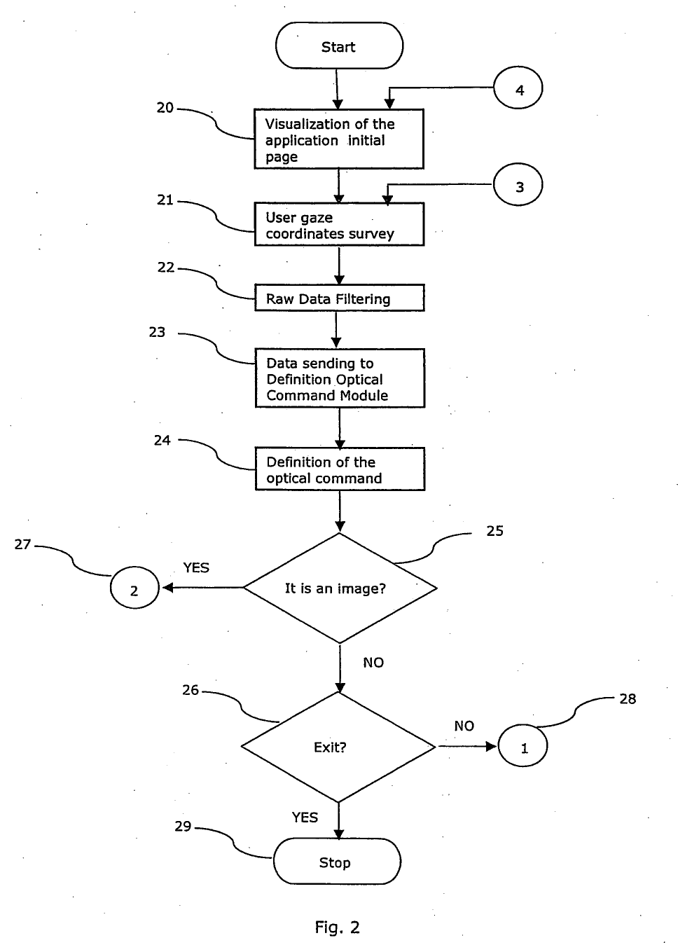

FIG. 2 illustrates the flow chart that represents the interconnections among the previously mentioned modules showing the steps of the method according to the present invention.
a) On the visualisation means associated to the computer which runs the program that performs the method according to the present invention, the initial page of the application that allows the user to interact with said program through an eye-tracker device.
b) The gaze coordinates of the user are calculated 21 by the eye-tracking device.
c) The raw data related to the above coordinates are filtered 22.
d) The filtered data coming from the previous step are sent 23 to the module relating to the optical command definition.
e) The optical command corresponding to the coordinates of the user gaze is determined 24.
f) A control is performed 25 on the type of optical command determined at the above step e), if it's related to image analysis, the sub-routine of image processing described in the following is launched 27, otherwise the action proceeds to the next step.
g) A further control is performed 26 on the type of optical command determined at the previous step e), if it concerns the ending command of the ongoing processing, then the running program ends 29, otherwise the “state machine” sub-routine as described in the following is recalled 28.

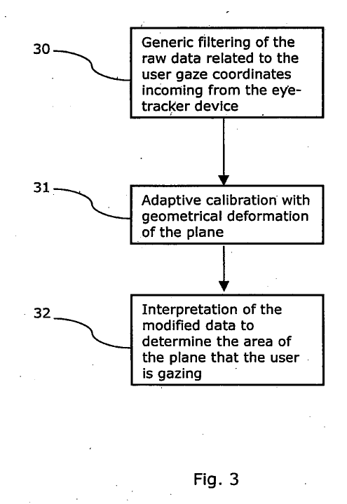

The step c) of the previously described sequence is performed by the module of filtering of the raw data according to the steps sequence described in the following and illustrated in FIG. 3:
h) The raw data incoming from the eye-tracking device are filtered 30 by a generic module in order to normalise the parameters so that they belong to a determined range of values.
i) Data are then processed 31 by a module for adaptive calibration that removes calibration problems that lead to phase displacement, due to the change of the environmental conditions, between the point gazed by the user and the point found by the eye-tracking device. For this purpose it can be used, as an example, a process of geometric deformation among planes in order to perform the correct calibration through a dynamic procedure based on least squares minimisation.
j) Data which now are stable are then fed 32 to a module of interpretation that allows to calculate the currently fixed portion of plane gazed by the user.

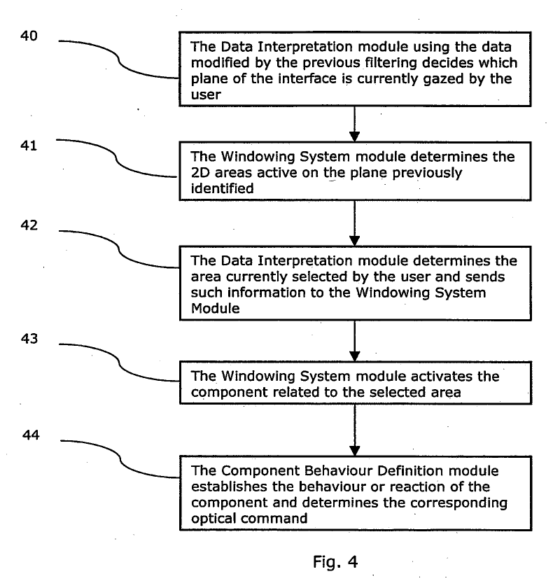

The management of the windows system and of the components, by the module for the definition of the optical command to activate, as mentioned at the previous step e) of the sequence illustrated in FIG. 2, works according to the following sequence shown and illustrated in FIG. 4:
k) The module dedicated to the interpretation of data which has been processed by the previous filtering module determines 40 which plane of the interface is currently gazed at by the user.
l) The module called Windowing System determines 41 the 2 D areas active on the plane identified in the previous step, that is the various zones, belonging to the plane gazed by the user, with which the user himself can interact.
m) The module dedicated to data interpretation, according to the information about the 2 D active areas supplied by the Windowing System module at the previous step, determines 42 the area that the customer has currently selected and sends such information to the Windowing System module.
n) The Windowing system module 43 activates the component of the graphical interface, that can be the button, the window and/or every other element of interaction with the user, related to the selected area.
o) The module of components behaviour definition establishes 44 the behaviour or the reaction of the component activated at the previous step, determining the corresponding optical command.

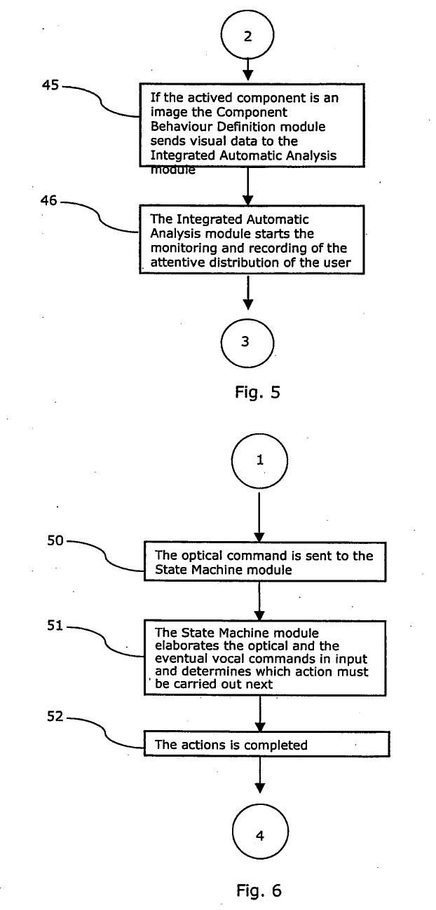

The sub-routine of images processing described at the previous step f) works according to the sequence of steps described in the following and illustrated in FIG. 5:
p) The module of component behaviour definition sends 45 the visual data to the module of integrated automatic analysis
q) The module of integrated automatic analysis starts 46 the monitoring and the recording of the attention distribution of the user
r) Return to the step b) previously described

The command definition and the following action takes place, by means of the “state machine” sub-routine previously mentioned at step g), according to the following sequence illustrated and represented in FIG. 6:
s) The optical command determined at step e) is sent to the “State Machine” module.
t) The State Machine module elaborates the optical and the eventual vocal commands that have been received and determines which action must be carried out next.
u) The action determined at the previous step is carried out.
v) Return to the step a) previously described.

For example, among the executable optical commands it is possible to choose commands related to the visualisation or to the processing of images (full screen image, increase/decrease zoom, increase/decrease brightness, increase/decrease contrast, angles measurement, distance measurement etc.) or general commands like help menu, panning and scrolling of the image, patient's selection, copy/paste of galleries of images or single images, choice of the grid of visualisation of galleries or images, analysis of an area of interest. As a further example, operating modes can be chosen in order to set a different speed of scrolling for different areas of the window, a different time of reaction of the buttons according to their position, their function, etc.

Considering, for example, the procedure for the selection of the patient in order to visualise the images related to his medical tests, the following actions are performed:

the patient is selected in a list of available patients through optical command

the activation of the above selection can be done in the following ways:
through optical control by detecting, for instance, the dwelling or staring time of the gaze on the icon or on the active object
through vocal control by using a keyword for example “select patient” or similar

Likewise, if the levels of contrast of a selected image has to be changed:

the icon related to the contrast into the control panel is selected through optical command

the activation of the functions “increase the contrast” or “decrease the contrast” takes place:
through optical control for instance determining the dwelling time or staring of the gaze on the icon or on the active object
through vocal control using, for instance, a keyword

1. System for the visualisation of medical images associated to computing means comprising means of graphic visualisation of information, characterized in that it comprises an eye-tracker device and an optional speech recognition device.

2. System according to claim 1 providing automatic feedback to the user, concerning his own visual exploration and attentive distribution, elaborating the signals received by an eye-tracking device.

3. System according to claim 2 comprising modules of management of programs for graphic visualisation of information that manage the interaction of the user with the displayed images on said means of graphic visualisation of information, processing the signals received by an eye-tracking device and from an optional speech recognition device.

4. System according to the claim 3 wherein said modules of management of programs for graphic visualisation of information comprise a filtering module of raw data incoming from the eye-tracking device, a so-called “optical command definition” module, for the application graphical interface management and for linking to the commands given by the user, a module of integrated automatic analysis that provides to the user an automatic feedback based on the analysis of the visual exploration performed by the subject and of his attentive distribution and a so-called “achievement of the action” module, that determines the action to perform.

5. Method for the control of computing means associated to means of graphic visualisation of information, at least an eye-tracking device, an optional speech recognition device and a program for graphic visualisation of information comprising the following steps:
a) The initial page of the application is displayed on the means of visualisation of information associated to the electronic computing means that runs the program which performs the method according to the present invention, said initial page allowing the user to interact with said program through an eye-tracker device and an optional speech recognition device associated to said electronic computing means;
b) The gaze coordinates of the user are calculated by the eye-tracking device;
c) The raw data related to the above coordinates are filtered;
d) The filtered data coming from the previous step are sent to the module relating to the optical command definition;
e) The optical command corresponding to the coordinates of the user gaze is determined;
f) A control is performed on the type of optical command determined at the above step e), if it's related to image analysis, the sub-routine of image processing described in the following is launched, otherwise the action proceeds to the next step;
g) A further control is performed on the type of optical command determined at the previous step e), if it concerns the ending command of the ongoing processing, then the running program ends, otherwise the “state machine” sub-routine is recalled.

6. Method according to the claim 5 wherein said optical commands determined at the previous step e) are selected in the group that comprises: commands related to the visualisation of images, commands related to the processing of images and general commands like help menu, panning and scrolling of the image, patient's selection, copy/paste of galleries of images or single images, choice of the grid of visualisation of galleries or images and analysis of the area of interest.

7. Method according to claim 5 wherein said step c) is carried out through the following steps:
h) The raw data incoming from the eye- tracking device are filtered by a generic module in order to normalise the parameters so that they belong to a determined range of values;
i) Data from the previous step are then processed by a module for adaptive calibration that removes possible problems of calibration and of phase displacement between the point gazed by the user and the point calculated by the eye- tracking device;
The data coming from the previous step are elaborated by a module of interpretation that allows to determine the portion of plane currently gazed by the user.

8. Method according to claim 5 wherein said step i) is performed through a process of geometric deformation that realises the correct calibration applying a dynamic procedure based on a least squares minimisation.

9. Method according to claim 5 wherein said step e) is performed through the followings steps:
k) The module for the interpretation of data processed by said filtering module determines which plane is currently gazed by the user;
l) The Windowing System module determines the 2D active areas on the plane identified in the previous step;
m) The module dedicated to data interpretation determines the area that the user has selected and sends that information to the Windowing System Module;
n) The “Windowing System” module activates the component of the graphical interface related to the selected area;
The “components behaviour definition” module establishes the behaviour or the reaction of the component activated at the previous step, determining the corresponding optical command.

10. Method according to claim 5 wherein said image processing subroutine is performed through the following steps:
o) The component behaviour definition module sends the visual data to the integrated automatic analysis module;
p) The integrated automatic analysis module starts monitoring and recording the user attention distribution.
Return to the above step b).

11. Method according to claim 10 wherein said “state machine” sub-routine is performed through the following steps:
q) The optical command determined at step e) is sent to the “State Machine” module;
r) The “State Machine” module processes the received optical and optionally vocal commands, and it determines which action has to be taken;
s) The action determined at the previous step is performed;
Return to the above step a)

12. Computer program comprising computer program code means adapted to perform all the steps of claim 5, when said program is run on a computer.

13. A computer readable medium having a program recorded thereon, said computer readable medium comprising computer program code means adapted to perform all the steps of claim 5, when said program is run on a computer.
